(19) United States
(12) Patent Application Publication
(10) Pub. No.: US 2013/0145441 A1
(43) Pub. Date: Jun. 6, 2013

(54) CAPTCHA AUTHENTICATION PROCESSES AND SYSTEMS USING VISUAL OBJECT IDENTIFICATION

(71) Applicants: Dhawal Mujumdar, Berkeley, CA (US); Satish Polisetti, Berkeley, CA (US)

(72) Inventors: Dhawal Mujumdar, Berkeley, CA (US); Satish Polisetti, Berkeley, CA (US)

(21) Appl. No.: 13/488,245

(22) Filed: Jun. 4, 2012

Related U.S. Application Data
(60) Provisional application No. 61/493,281, filed on Jun. 3, 2011.
(60) Provisional application No. 61/494,802, filed on Jun. 8, 2011.

(51) Int. Cl. G06F 21/30

(52) U.S. Cl. CPC G06F 21/305
USPC 726/5

(57) ABSTRACT

Systems and processes for performing user verification using an imaged-based CAPTCHA are disclosed. The verification process can include receiving a request from a user to access restricted content. In response to the request, a plurality of images may be presented to the user. A challenge question or command that identifies one or more of the displayed plurality of images may also be presented to a user. A selection of one or more of the plurality images may then be received from the user. The user's selection may be reviewed to determine the accuracy of the selection with respect to the challenge question or command. If the user correctly identifies a threshold number of images, then the user may be authenticated and allowed to access the restricted content. However, if the user does not correctly identify the threshold number of images, then the user may be denied access the restricted content.

### CROSS-REFERENCE TO RELATED APPLICATION

This application claims the benefit, under 35 U.S.C. §119(e), of U.S. Provisional Patent Application No. 61/493,281, filed Jun. 3, 2011, and entitled “Captcha Authentication Processes and Systems Using Visual Object Identification” and U.S. Provisional Patent Application No. 61/494,802, filed Jun. 8, 2011, and entitled “Captcha Authentication Processes and Systems Using Visual Object Identification,” the contents of which are incorporated by reference in their entirety for all purposes.

### BACKGROUND

1. Field

This application relates generally to authenticating user access to online content and, more particularly, to a system and method for user authentication using computer-generated visual object identification tests to distinguish between humans and automated software applications.

2. Related Art

Completely Automated Public Turing Tests to Tell Computers and Humans Apart (CAPTCHAs) are commonly used to improve web security by preventing abuse by spam bots or other automated computer-based trolls. For example, CAPTCHAs, often consisting of a blurry image containing several letters or words, can be presented to users prior to the users being able to access a particular online resource. The users may then be required to verify that they are human by typing the letters or words contained in the CAPTCHA into a text field. While this technique can be used to restrict the access of automated software applications, it can also produce a frustrating experience for a user. For example, CAPTCHAs can be difficult to use on mobile devices, such as smartphones and tablet computers, because users must zoom/pan in order to view the CAPTCHA at a suitable size. Additionally, conventional CAPTCHA solutions, such as type-in CAPTCHAs, are typically either too simple, allowing automated software applications to circumvent the CAPTCHA using character recognition techniques, or are too difficult to comprehend, creating a frustrating user experience.

### SUMMARY

Systems and processes for performing user verification using an imaged-based CAPTCHA are disclosed. In one example, the verification process can include receiving a request from a user to access restricted content. In response to the request, a plurality of images may be presented to the user. A challenge question or command that identifies one or more of the displayed plurality of images may also be presented to a user. A selection of one or more of the plurality images may be received from the user in response to the challenge question or command. The user's selection may be reviewed to determine the accuracy of the selection with respect to the challenge question or command. If the user correctly identifies a threshold number of images, then the user may be authenticated and allowed to access the restricted content. The restricted content can be web registration of a service, filling up a contact form, purchasing a ticket, reading a premium digital article/publication (paywalls), downloading media files, playing a video, and the like. However, if the user does not correctly identify the threshold number of images, then the user may be denied access the restricted content. In some examples, if the user is denied access to the restricted content, a new set of images and a new challenge question or command may be presented to the user. In some examples, some or all of the displayed images and/or the challenge question or command may contain advertisement data, such as brand logos, names, and the like.

### BRIEF DESCRIPTION OF THE DRAWINGS

The present application can be best understood by reference to the following description taken in conjunction with the accompanying figures.

FIG. 1 illustrates an exemplary image-identification CAPTCHA according to one embodiment of the present disclosure.

FIG. 2 illustrates an exemplary image-identification CAPTCHA that utilizes advertisements according to one embodiment of the present disclosure.

FIG. 3 illustrates an exemplary image-identification CAPTCHA for a web page according to one embodiment of the present disclosure.

FIG. 4 illustrates an exemplary follow-up page that appears after the completion of the web page shown in FIG. 3.

FIG. 5 illustrates an exemplary deployed view of FIG. 1 in a web page with ads and with a Send offer option.

FIG. 6 illustrates a block diagram of an exemplary image database.

FIG. 7 illustrates an exemplary process for performing user verification using an imaged-based CAPTCHA according to one embodiment of the present disclosure.

FIG. 8 illustrates another exemplary process for performing user verification using an imaged-based CAPTCHA with validation on a CAPTCHA server according to one embodiment of the present disclosure.

FIG. 9 illustrates another exemplary process for performing user verification using an imaged-based CAPTCHA with validation on a Content Host Server according to one embodiment of the present disclosure.

FIGS. 10-14 illustrate example questions that may be asked in an imaged-based CAPTCHA.

FIG. 15 illustrates an exemplary system that can be used to perform user verification using an imaged-based CAPTCHA according to the embodiments of the present disclosure.

FIG. 16 depicts an exemplary paywall system 1600 with an image CAPTCHA unit.

### DETAILED DESCRIPTION

In the following description of example embodiments, reference is made to the accompanying drawings in which it is shown by way of illustration specific embodiments that can be practiced. It is to be understood that other embodiments can be used and structural changes can be made without departing from the scope of the various embodiments.

This relates to systems and processes for performing user verification using an imaged-based CAPTCHA. The verification process can include receiving a request from a user to access restricted content. In response to the request, a plurality of images may be presented to the user. A challenge question or command that identifies one or more of the displayed plurality of images may also be presented to a user. A selection of one or more of the plurality images may be received from the user in response to the challenge question or command. The user's selection may be reviewed to determine the accuracy of the selection with respect to the challenge question or command. If the user correctly identifies a threshold number of images, then the user may be authenticated and allowed to access the restricted content. However, if the user does not correctly identify the threshold number of images, then the user may be denied access the restricted content. In some examples, if the user is denied access to the restricted content, a new set of images and a new challenge question or command may be presented to the user.

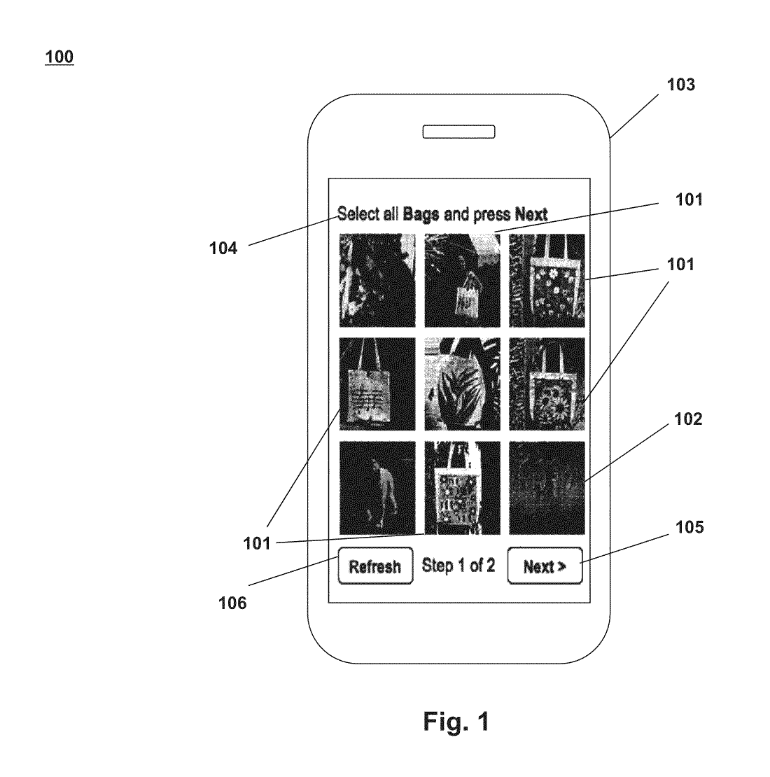

FIG. 1 illustrates a view 100 of an image-identification CAPTCHA on a mobile device 103. The image-identification CAPTCHA may include a challenge question or command 104 that, in this example, instructs the user to select a particular image or type of image from a set of images. For example, challenge question or command 104 may instruct the user to identify all images containing a bag or to identify a subset of all images containing a bag. Example target images (e.g., images identified by the challenge question or command 104) containing a bag are identified by reference numeral 101 in FIG. 1. One example non-target image (e.g., images that are not identified by the challenge question or command 104) in the image-identification CAPTCHA is identified by reference number 102. It should be appreciated that there are additional non-target images in FIG. 1 and that the image identified by reference numeral 102 is provided only as an example. In some examples, view 100 of the image-identification CAPTCHA may further include refresh button 106 through which the user can request a new set of images and a different challenge question or command 104. View 100 of the image-identification CAPTCHA can further include a next button 105 to proceed to the next screen/page once user has entered their selection of the target images.

In some embodiments, the image-identification CAPTCHA may include a plurality of images and a challenge question or command 104 that describes or identifies one or more of the plurality of images. To “pass” the imaged-based CAPTCHA, the user may correctly identify some or all of the images described or identified by the challenge question or command 104. Thus, unlike traditional text-based CAPTCHAs, a user may respond to the CAPTCHA by simply clicking or otherwise selecting one or more of the displayed images.

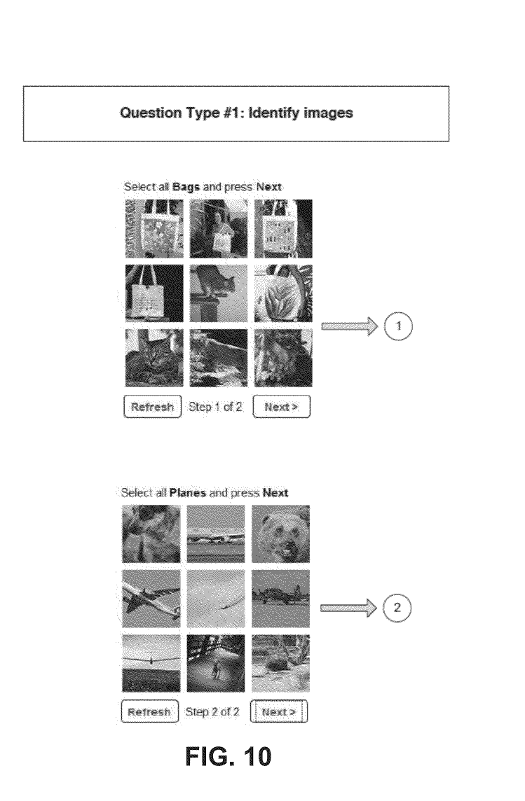

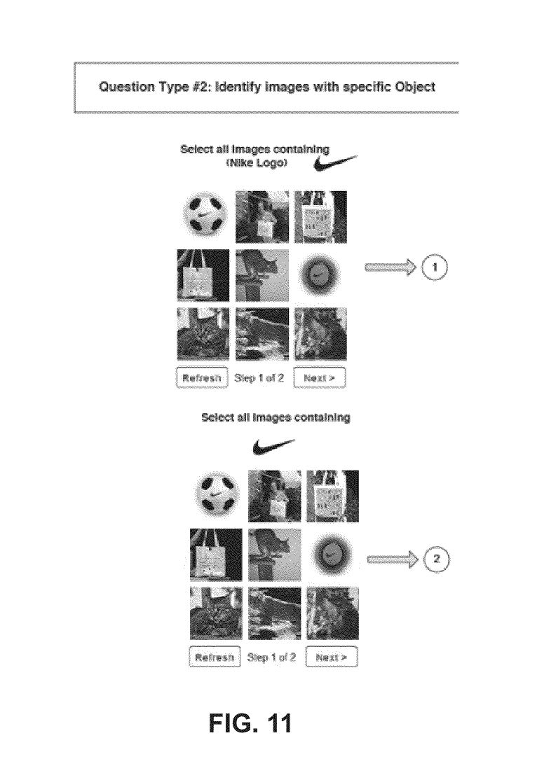

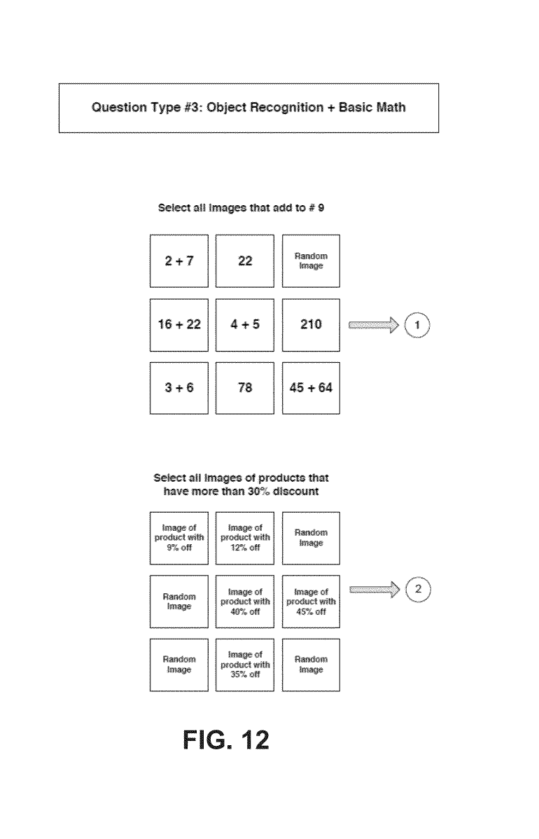

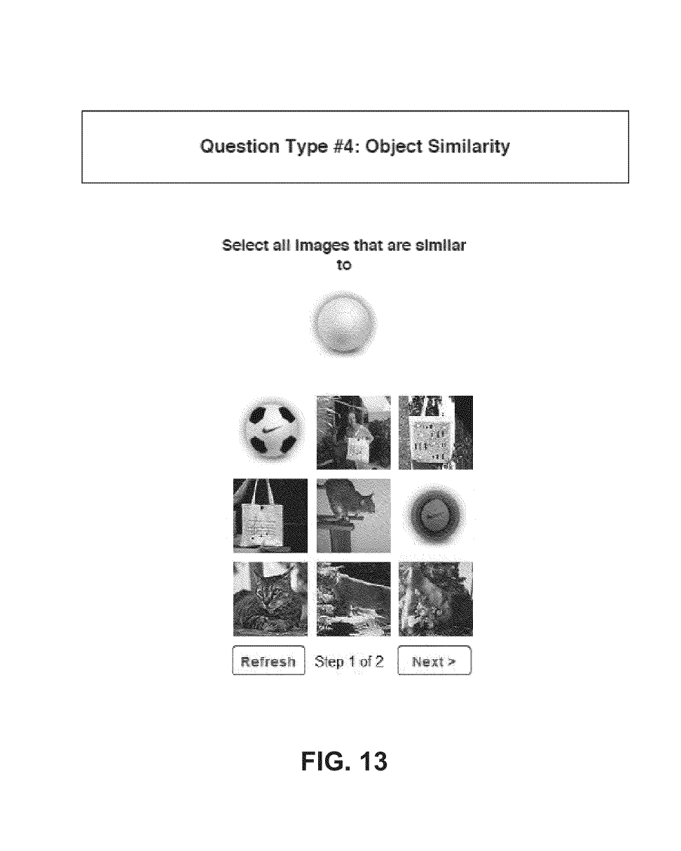

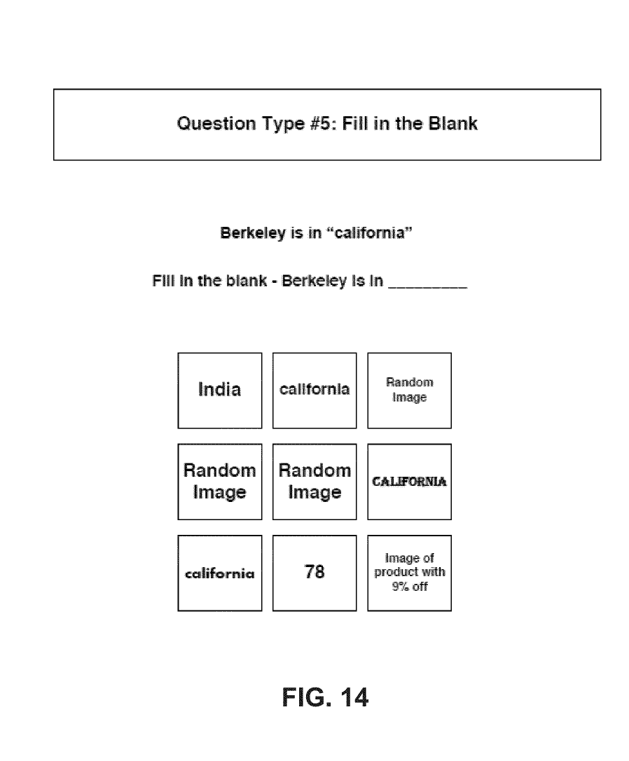

It should be appreciated that the images and challenge question or command 104 are provided only as examples and that other images and questions or commands may be used. For example, additional example images and challenge questions or commands are illustrated in in FIGS. 10-14.

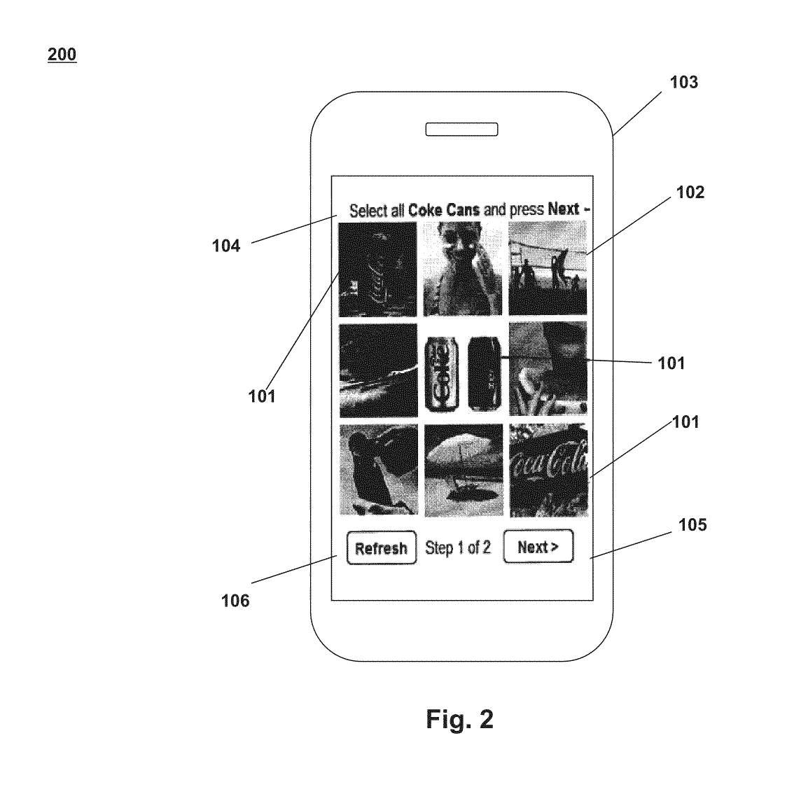

FIG. 2 illustrates another example view 200 of an image-identification CAPTCHA. Similar to view 100 of FIG. 1, view 200 may be displayed on device 103 and may include target images 101, non-target images 102 (one example image is labeled in FIG. 2), challenge question or command 104, refresh button 106, and forward button 105. However, in this example, some or all of the images (e.g., target images 101) may include brand advertisements. Additionally, the challenge question or command 104 may instruct the user to select one or more images associated with a particular brand (e.g., a soda manufacturer). This type of image-identification CAPTCHA can be used to authenticate a user as well as provide a means for advertising.

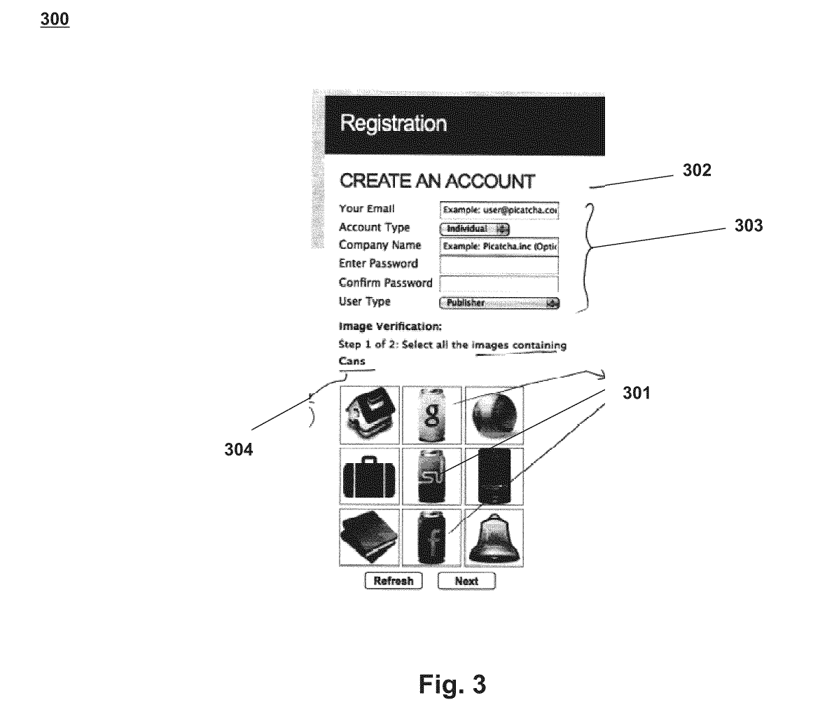

FIG. 3 illustrates an example view 300 of a registration/sign-up page 302 in a fully deployed version of the image-identification CAPTCHA. Page 302 may include text boxes or other information input means 303 to allow the user to input their account information to sign up for the service associated with page 302. Page 302 may further include an image-identification CAPTCHA having a challenge question or command 304. In the illustrated example, challenge question or command 304 instructs the user to select “all the images containing Cans.” Three example target images are identified by reference numeral 301. In some examples, as illustrated by FIG. 3, some or all of the target or non-target images may include brand logos or advertisements (e.g., logos for Google, Facebook, etc.).

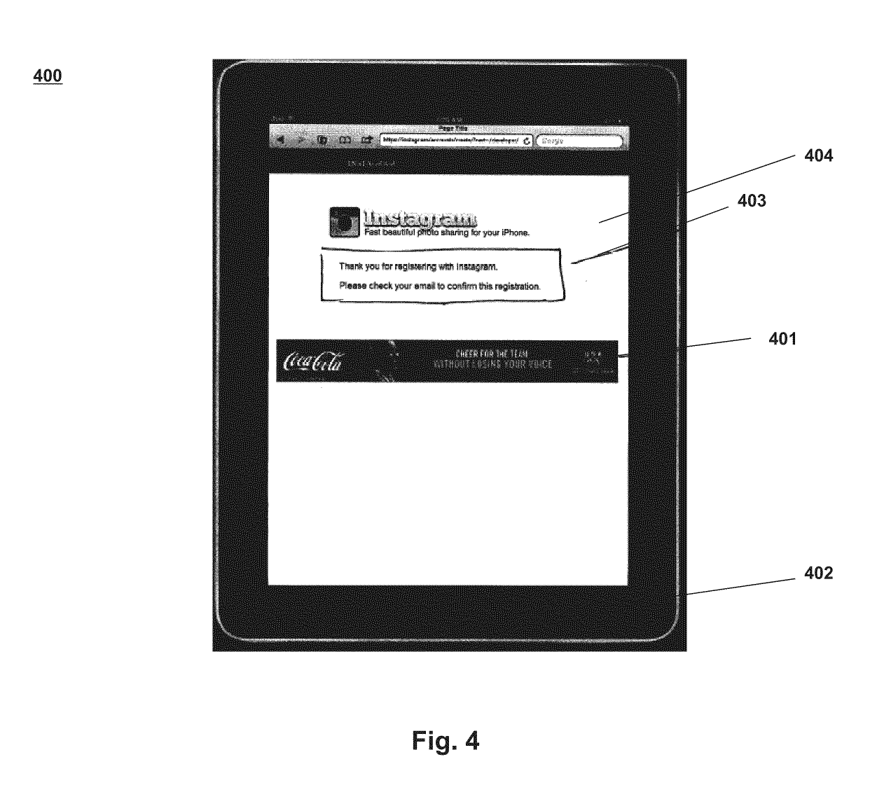

FIG. 4 illustrates a view 400 of an example page 404 indicating a successful registration using registration/sign-up page 302 of FIG. 3. Page 404 is shown on a tablet computer 402. Page 404 may include indication 403 notifying the user that the registration is complete. Page 404 may further include advertisement 401 which, in this example, includes a banner advertisement for Coke. In some examples, in response to a selection of advertisement 401, the user may be directed to a website associated with the banner advertisement company. In some examples, the brand displayed in the target images of a previously displayed image-identification CAPTCHA (e.g., image-identification CAPTCHA shown in FIG. 2 and/or 3) may be the same or different from the brand associated with advertisement 401.

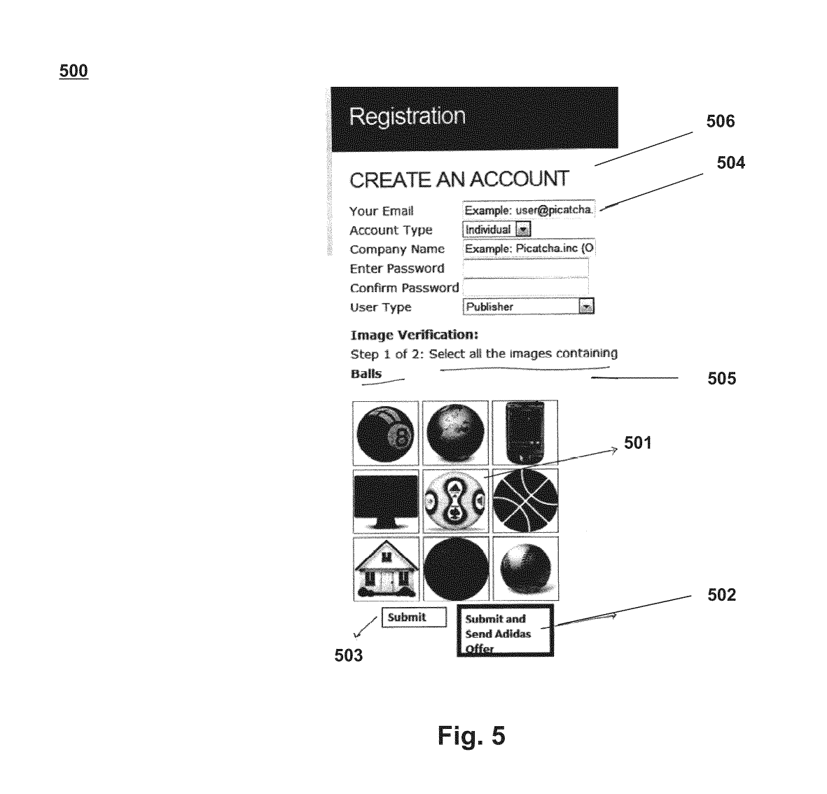

FIG. 5 illustrates a view 500 of a registration/sign-up page 506. Page 506 may include text boxes or other information input means 504 to allow the user to input their account information to sign up for the service associated with page 506. Page 506 may further include an image-identification CAPTCHA having a challenge question or command 505. In the illustrated example, the challenge question or command 505 instructs the user to “Select all the images containing Balls.” The image-identification CAPTCHA may further include one or more target image(s) 501 (only one example is labeled in FIG. 5). In some examples, the target image(s) 501 may include an advertisement image (e.g., a logo for Adidas). Page 506 may further include a submit button 503 through which the user can finalize their selection. Additionally or alternatively, page 506 may further include a submit and send offer button 502 that submits the user's entries and also request a coupon or discount code to be sent to the user. Variations of button 502 may be used. For example, the option may include a “Submit & Save Ad,” “Submit & Get Offer,” “Submit & Participate in Brand Survey,” or the like. In some examples, the contact information provided in input means 504 can be used by the advertiser to contact the user.

The total number of images used in the image-identification CAPTCHAs discussed above can be any number. For example, 9, less than 9, or greater than 9 images may be used. Additionally, any number of screens (or stages) can be used. For example 2, less than 2, or greater than 2 screens can be used. The number of screens and images per screen may be modified to adjust the difficulty, and thus the level of security, provided by the image-identification CAPTCHA. Using FIG. 3 as an example, the image-identification CAPTCHA in FIG. 3 may include 2 screens (stages) with 9 images in each screen. The first screen may be displayed having 9 images. In response to the user correctly identifying the target images and selecting the “Next” button, a second screen having another set of 9 images may be displayed. The size of target images and non-target images may be adopted and customized to the type of browser and device. In some examples, the number of target images in an imaged-based CAPTCHA may be any number between 1 and K, where K is the total number of images in the CAPTCHA. In other examples, the imaged-based CAPTCHA may include zero target images or all images in the imaged-based CAPTCHA may be target images.

Additionally, in some examples, the user may be required to correctly identify all images described or identified by the challenge question or command. In other examples, the user may only be required to identified a predetermined number or subset of the target images. For example, an image-identification CAPTCHA may include 9 images containing 3 target images. In some examples, the user may be required to identify all 3 target images without selecting any non-target images. In other examples, the user may be required to correctly identify less than all 3target images and/or may be allowed to incorrectly select one or more non-target images. The number of target images and non-target images may be modified to adjust the difficulty, and thus the level of security, provided by the image-identification CAPTCHA.

The web page/applications shown FIGS. 3 and 5 can be implemented for any platform—PHP, Java, Pyhton, Drupal, Wordpress, Joomla, etc. The webpage can be a sign-up page, sweepstake pages, comments page, send—sms, online survey, voting/polling page, bidding form and the like where the webpage needs to confirm that the participation is happening via a human and not a automated script/bot. Images shown in FIGS. 3 and 5 may be of any format—jpeg, jpg, png, gif or svg, and the like. The target images in FIGS. 3 and 5 may include an advertisement as a part of the image (Adidas in FIG. 5 on target image 501). The CAPTCHA challenge questions or commands can be generic (e.g., “select cans”) or may be advertiser specific as (e.g., “select coke cans”).

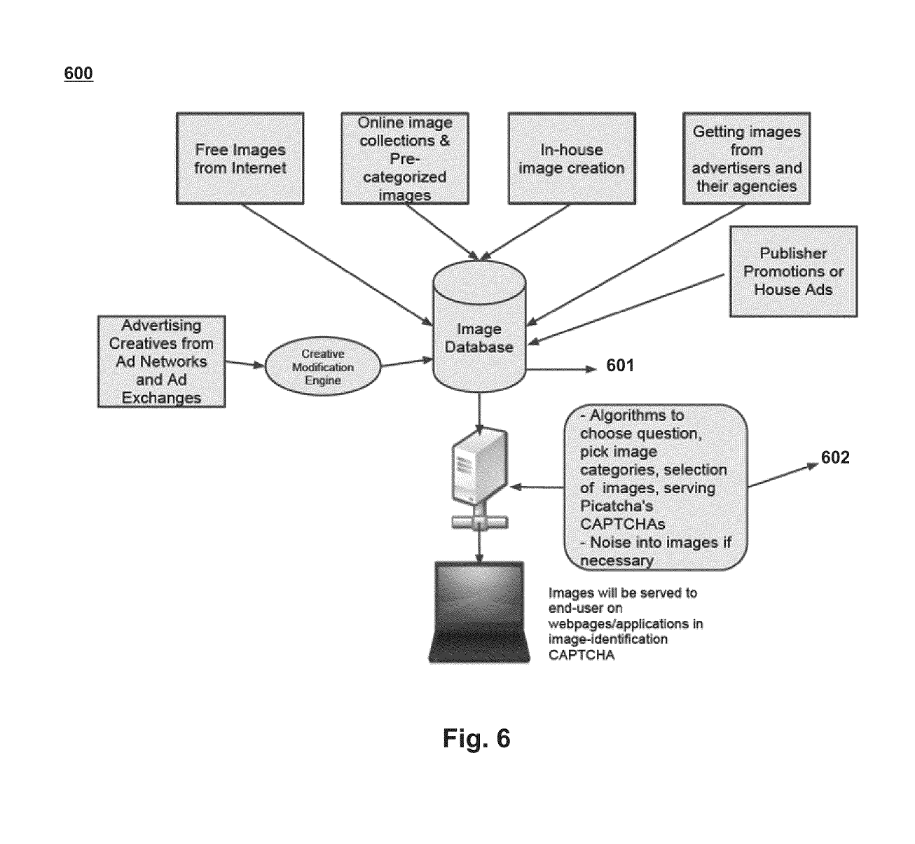

FIG. 6 illustrates an exemplary process and system 600 for building an image database 601 from one or more different sources. The images may be stored in database 601 using several techniques (random hashes as file names, multiple hashes for the same file) and the like to ensure high security. Selection algorithms 602 may include techniques, such as sub-clustering, personalization, contextual targeting, content based targeting, and the like before sending them to a publisher webpage/application. It may also include user interaction models built using the previous data of users interacting with the system. Noise 602 in form of image distortion, changing pixilation, blurring image, and the like, can be added in certain instances.

Some of the sources in FIG. 6 can include free/royalty-free images that can be used for commercial purposes. Additionally, images may be gathered from image collections and image tagging companies which will be pre-categorized. Images may also come directly from advertisers and their agencies. Publishers can promote their own products (house-ads) as part of the images. These house-ads can come directly from the publisher or generated by mining their websites. System 600 may also generate dynamic images using algorithms, such as visualization libraries and the like. The system 600 may also plug into ad networks & ad exchanges to get advertisement creative's in real time. All the images from various sources can be manually collected, queried using APIs (if they exist), or via Secure FTP transfers.

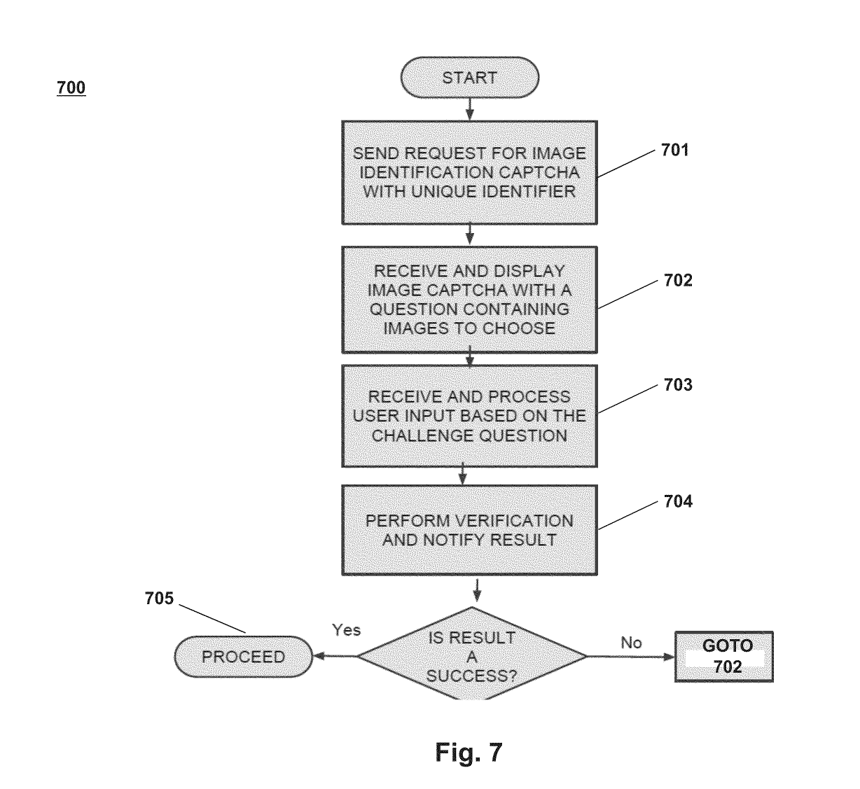

FIG. 7 illustrates an exemplary process 700 for performing user verification using an imaged-based CAPTCHA. At block 701, a content host server may send a request for CAPTCHA authentication when a user requests access to protected content. A central CAPTCHA server may receive the request from the content host server and process the request by generating one or more challenge questions randomly for each of the ‘k’ steps of CAPTCHA challenge. The CAPTCHA server may then select a predetermined number or range of numbers of target images (e.g., 2-7 target images for an imaged-based CAPTCHA containing 9 images) related to the CAPTCHA question. Additional images can be chosen randomly from the image database to fill the remaining slots of the imaged-based CAPTCHA. However, care is taken so that target images are not similar in pictorial representation to the rest of the images. CAPTCHA data containing links to images and a challenge question may then be sent to the content host server. The images may always be present on the CAPTCHA server and the content host server may only receive links to these images. The links may be encrypted using hash algorithms (MD5, SHA etc) to make it difficult for attackers to decipher the content of the image by the image name. The system may also have more than just one hash name for each image. Each image may be mapped to more than one hash value and different hash values can be used while serving the same image. Alternatively, the actual images may be transmitted to the content host server.

At block 702, the content host server may receive and display the CAPTCHA images with challenge questions or commands (e.g., similar to that shown in FIGS. 1-3 and 5). At block 703, the content host server may receive and process a user response (input) (e.g., selection of images from the images displayed at block 702, tracking information like relative pixel positions while user interacts with the images and the like). At block 704, the content Host server may either send the user selection to the central CAPTCHA server or may perform validation locally. If the validation is a success, the user is allowed to proceed at block 705 to the restricted access content. If, however, the validation is not a success, the process returns to block 702 where another imaged-based CAPTCHA is presented to the user.

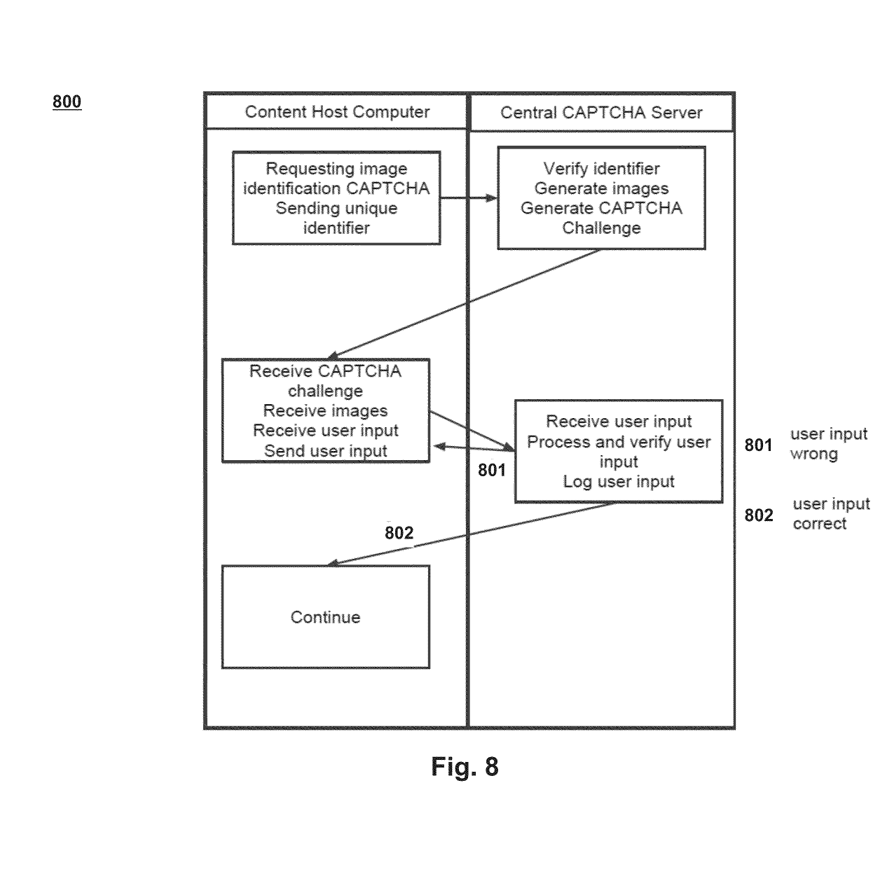

FIG. 8 illustrates an exemplary process 800 that is a variation of process 700 in which the validation is performed at the CAPTCHA server. Specifically, the content host server may send user's input to the CAPTCHA server, which verifies the input and gives response whether CAPTCHA challenge was cleared or not.

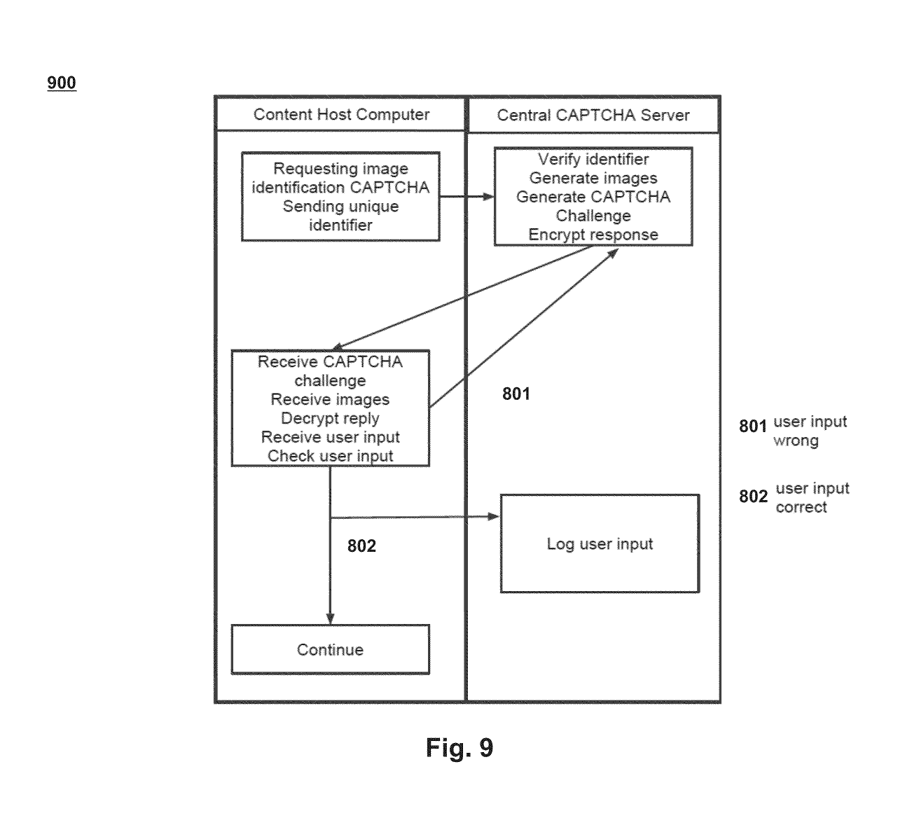

FIG. 9 illustrates an exemplary process 900 that is a variation of process 700 in which the validation is performed at the content host server. In this example, CAPTCHA server sends expected correct response to Content Host Server in an encrypted manner. When user submits the input, Content Host Server verifies whether CAPTCHA challenge was cleared or not based on the user input. On successful completion of CAPTCHA challenge, the publisher shows the user with the next page (e.g., block 705 of FIG. 7).

In order to reduce the chances of image scraping by an attacker—in one example, the system may randomly serve all images as a single unit and may use image maps to get the user response. The system may also use IP monitoring, publisher rate limits to reduce attacks. In another example, the system randomly serves images within HTML5 elements (e.g. Canvas element). The positions of the images may dynamically change to protect against attackers who use human solvers. A user expiration time (predefined number of seconds) within which the user is expected to solve the CAPTCHA may be set. If a user fails to solve the CAPTCHA in this period, a fresh CAPTCHA may be requested. This will safeguard the system from attackers who want to outsource the CATPCHA challenge to human solvers. A system may also include watermarks, noise (distortions, blurring etc) when required to prevent pattern matching attacks.

Advertisers can be allowed to configure campaigns and specify the parameters for showing their advertisements. These include—device, geography, age, type of content of publishers, frequency capping, campaign duration etc. The advertisers may also specify their budgets and bid amounts for each ad. The ad-serving algorithm will assign priorities using the bid amounts and the probability of match between the CAPTCHA request and advertiser parameters. In order to contextualize the ads shown CAPTCHA challenges, our system will plug into data partners (e.g. Rapleaf, IXI, Bluekai, V12, AlmondNet etc). Demographic, financial, behavior, shopping/search intent data from the data partner companies will be used to contextualize the ads both for advertisers campaigns and also for publisher house-ads.

Advantages of the exemplary image-identification CAPTCHA describe above include:
a. It is mobile friendly—typing is painful on mobile devices, where as touching or scrolling to select images is easy
b. It is desktop friendly—clicking with mouse is quicker than typing
c. It is easy to comprehend—pictures are more easy to understand than to infer garbled, distorted texts
d. The whole user experience is improved both on desktop and mobile devices (including smartphones and tablet computer)
e. Security of this new CAPTCHA may be greater compared to type-in CAPTCHAs.

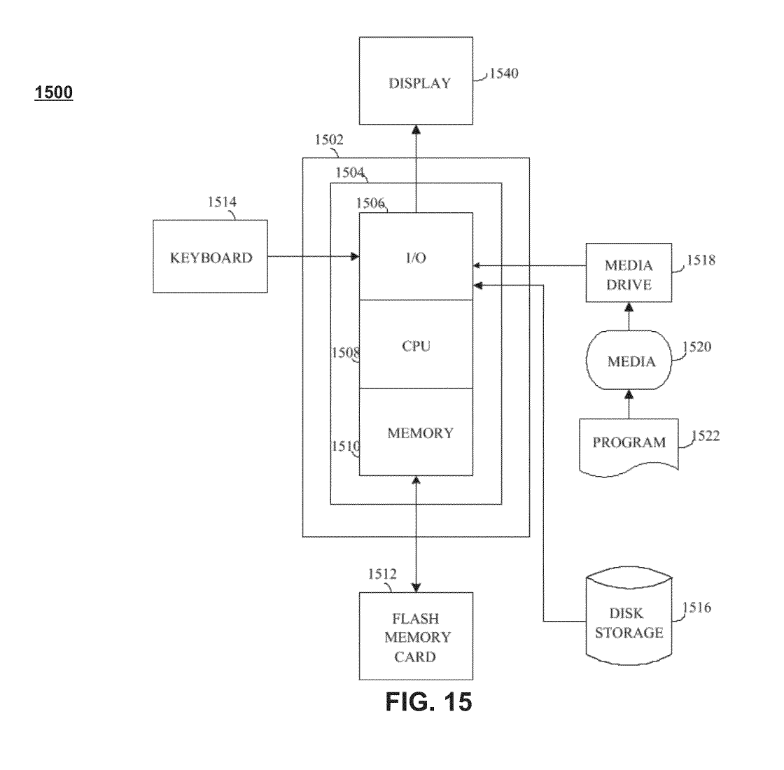

FIG. 15 depicts an exemplary computing system 1500 with a number of components that may be used to perform the above-described processes. The main system 1502 may include a motherboard 1504 having an input/output (“I/O”) section 1506, one or more central processing units (“CPU”) 1508, and a memory section 1510, which may have a flash memory card 1512 related to it. The I/O section 1506 may be connected to display 1540, a keyboard 1514, a disk storage unit 1516, and a media drive unit 1518. The media drive unit 1518 can read/write a non-transitory computer-readable storage medium 1520, which can contain programs 1522 and/or data.

At least some values based on the results of the above-described processes can be saved for subsequent use. Additionally, a non-transitory computer-readable storage medium can be used to store (e.g., tangibly embody) one or more computer programs for performing any one of the above-described processes by means of a computer. The computer program may be written, for example, in a general-purpose programming language (e.g., Pascal, C, C++) or some specialized application-specific language.

In one broad embodiment, the present technology offers improved user experience and security compared to existing alternatives. Additionally, attached hereto is an appendix of additional examples and features of different aspects of the described technology.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

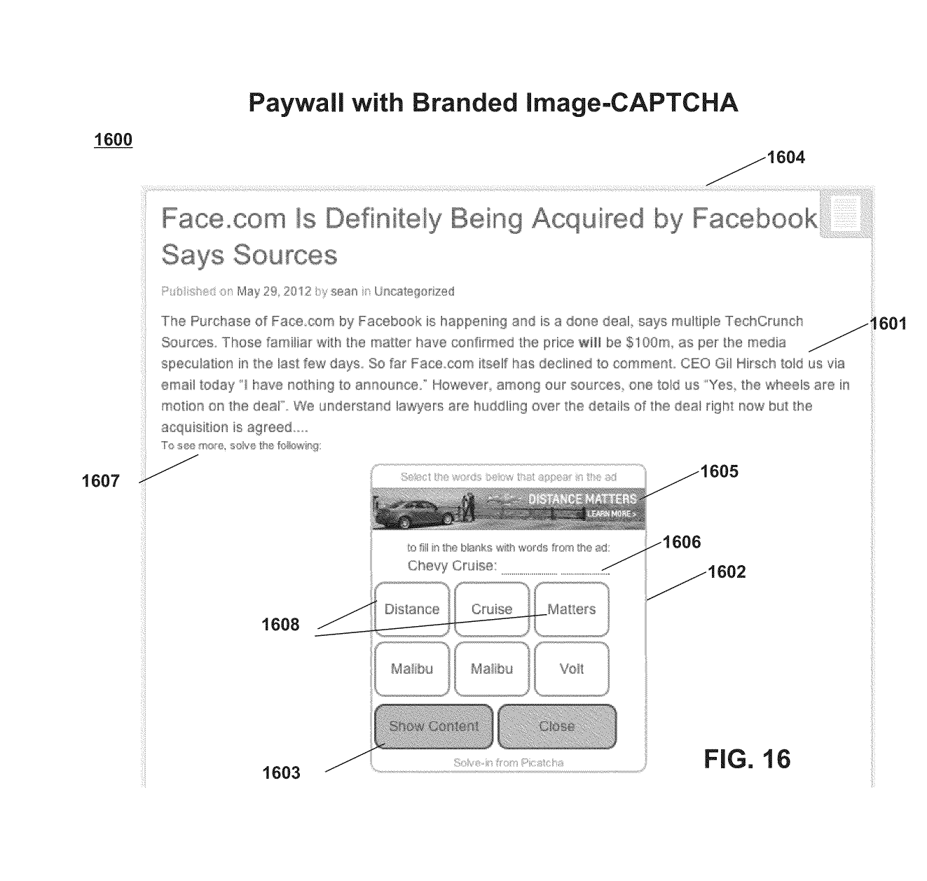

FIG. 16 depicts an exemplary paywall system 1600 with an image CAPTCHA unit. The system may include a web page 1604 with a premium article 1601. The restricted view of the article is made available for immediate consumption. The instruction 1607 directs the visitor to solve the branded image CAPTCHA to get access to the complete content of the article. The system 1602 contains the challenge to the user and a collection of images. 1605 is the advertisement containing a brand message. The user may select the appropriate images 1608, causing the images or words to appear at blanks 1606 to provide visual feedback. The user may then select button 1603 to get the complete article.

We claim:

1. A computer-implemented method for authenticating user access to online content, the method comprising:
a) receiving a request for user authentication;
b) generating one or more images in response to said request;
c) transmitting the one or more images;
d) receiving user feedback relating to the one or more images; and
e) providing to the content provider an authentication decision based on the user feedback in relation to the one or more images.

2. The method of claim 1, wherein the authentication decision indicates whether or not the user is human.

3. The method of claim 1, wherein if the authentication decision is negative, the method further comprises repeating steps b-e.

4. The method of claim 1, wherein the user feedback comprises a selection of one or more of the one or more images including tracking information of the user's interaction with the one or more images.

5. The method of claim 1, wherein step c further comprises transmitting a challenge question.

6. The method of claim 5, wherein the challenge question comprises an advertisement.

7. The method of claim 1, wherein the one or more images comprises an advertisement.

8. The method of claim 1, wherein if the authentication decision is positive, the method further comprises providing one or more advertisements.

9. The method of claim 1, wherein the one or more images are from an image database.

10. The method of claim 1, further comprising dynamically adding a plurality of noises to one or more of the one or more images.

11. The method of claim 1, wherein the one or more images are transmitted to a content provider.

12. The method of claim 1, wherein the one or more images are transmitted to the user.

13. A non-transitory computer-readable storage medium comprising computer-readable instructions comprising, the instructions comprising:
a) receiving a request for user authentication;
b) generating one or more images in response to said request;
c) transmitting the one or more images;
d) receiving user feedback relating to the one or more images; and
e) providing to the content provider an authentication decision based on the user feedback in relation to the one or more images.

14. The method of claim 13, wherein the authentication decision indicates whether or not the user is human.

15. The method of claim 13, wherein if the authentication decision is negative, the method further comprises repeating steps b-e.

16. The method of claim 13, wherein the user feedback comprises a selection of one or more of the one or more images.

17. The method of claim 13, wherein step c further comprises transmitting a challenge question.

18. The method of claim 13, wherein the one or more images comprises an advertisement.

19. The method of claim 13, further comprising blurring one or more of the one or more images.

20. A system for authenticating user access to online content, the system comprising:
a server;
a database of images;
a non-transitory computer-readable storage medium with computer-readable instructions comprising:
generating one or more images in response to receiving a request for user authentication;
providing the one or more images to a content provider; and
providing to the content provider an authentication decision based on user feedback related to the one or more images.
